(19) United States
(12) Patent Application Publication
(10) Pub. No.: US 2013/0120575 A1
(43) Pub. Date: May 16, 2013

(54) APPARATUS AND METHOD FOR RECOGNIZING ROAD MARKERS

(71) Applicant: Electronics and Telecommunications Research Institute, Daejeon (KR)

(72) Inventors: Jaemin BYUN, Daejeon (KR); Myung Chan ROH, Daejeon (KR); Ki In NA, Daejeon (KR); Sung Hoon KIM, Daejeon (KR)

(73) Assignee: Electronics and Telecommunications Research Institute, Daejeon (KR)

(21) Appl. No.: 13/673,108

(22) Filed: Nov. 9, 2012

(30) Foreign Application Priority Data
Nov. 10, 2011 (KR) 10-2011-0116970

(51) Int. Cl. H04N 7/18

(52) U.S. Cl. CPC H04N 7/18
USPC 348/148

(57) ABSTRACT

An apparatus for use in a vehicle identifies road markers. The apparatus includes a sensor unit configured to collect image information ahead of the vehicle, distance information, and information on the reflected amount of a road surface. The apparatus includes a recognizer unit configured to recognize the road markers ahead of the vehicle on the basis of the image information, distance information, and information on the reflected amount provided from the sensor unit. Information on the road markers recognized in the recognizer unit is provided on an output unit.

### RELATED APPLICATION(S)

This application claims the benefit of Korean Patent Application No. 10-2011-0116970, filed on Nov. 10, 2011, which is hereby incorporated by reference as if fully set forth herein.

### FIELD OF THE INVENTION

The present invention relates to recognition of road markers, and more particularly to an apparatus and method for correctly recognizing road markers regardless of the change in different surrounding environments and weather.

### BACKGROUND OF THE INVENTION

Technologies for road marker recognition have been developed to provide drivers with assistant apparatuses in order to guarantee driver's convenience and security in a road environment. A technology for recognizing road markers ahead of a vehicle has been developed in a form of an alarm apparatus that informs the vehicle of information on the markers ahead of the vehicle in advance in order to prevent the vehicle from being out of traffic lane or passing stop line or crosswalk marker, thereby preventing car accidents or human victims when drivers do not sense the markers with their carelessness.

In generally, a method for extracting the markers has been applied using image information taken by a camera in order to recognize the road markers and road information was scanned in a variety of angles using single/multiple cameras so as to remove image distortion and noise. Nonetheless, there are problems of sensibly responding to environmental elements such as various illumination changes and shadow and effects such as rain fall/show fall.

Further, because of using a single camera generally, there is a phenomenon where long distance information is distorted in the process that perspective information is transformed from two-dimensional information into three-dimensional information, and there is a restriction condition that the road surface should be flat.

### SUMMARY OF THE INVENTION

In view of the above, the present invention provides a apparatus and method for correctly recognizing road markers regardless of the change in different surrounding environments and weather.

Embodiments relates to an apparatus and method for recognizing road markers for use in a vehicle.

In the embodiments, the apparatus includes: a sensor unit configured to collect image information ahead of the vehicle, distance information, and information on the reflected amount of a road surface; a recognizer unit configured to recognize the road markers ahead of the vehicle on the basis of the image information, distance information, and information on the reflected amount provided from the sensor unit; and an output unit configured to provide information on the road markers recognized in the recognizer unit.

In the embodiments, the sensor unit includes: a camera configured to take an image ahead of the vehicle to generate the image information; and a laser scanner configured to generate the distance information and the information on the reflected amount.

In the embodiments, the recognizer unit includes: an image information processor configured to perform a transformation process of the image provided from the camera to generate an image ahead of the vehicle that is matched with a single coordinate system; a reflected amount information processor configured to normalize the information on the reflected amount; a distance information processor configured to separate a region of road surface and a region of non-road surface each other using the distance information to determine a region of interest (ROI); and a road marker recognition determiner configured to determine one or more road marker on the basis of the image, the normalized information on the reflected amount, and the region of interest.

In the embodiments, the image information processor includes: an inverse perspective transformer configured to transform the coordinate system of the image provided from the camera on the basis of camera parameters obtained from a calibration process of the camera to generate a bird-view image; and a noise filter configured to remove noise from the bird-view image to generate the image.

In the embodiments, the reflected amount information processor includes: a histogram processor configured to generate a histogram for the information on the reflected amount provided from the laser scanner; and a normalization processor configured to perform a normalization process for the information on the reflected amount on the basis of the histogram.

In the embodiments, the distance information processor includes: a map creator configured to create a three-dimensional elevation map for the road ahead of the vehicle using the distance information; and a ROI determiner configured to separate a region of road surface and a region of non-road surface each other on the basis of the three-dimensional elevation map to determine the ROI for recognition of the road markers.

In the embodiments, the road marker recognition determiner extracts edges in the ROI from the image, perform a line fitting based on the extracted edges, selects a group of road marker candidates in consideration of direction and size of the road markers, and recognize one or more road marker candidates from the group of road marker candidates based on the information on the reflected amount, thereby determining the one or more road markers.

In the embodiments, the method includes: sensing image information ahead of the vehicle, distance information, and information on the reflected amount of a road surface; recognizing road markers ahead of the vehicle on the basis of the image information, distance information, and information on the reflected amount; and presenting information on the recognized markers.

In the embodiments, the sensing image information ahead of the vehicle includes: taking an image ahead of the vehicle using a camera to generate the image information; and scanning the road surface ahead of the vehicle to generate the distance information and information on the reflected amount.

In the embodiments, the recognizing road markers ahead of the vehicle includes: performing a transformation process on a coordinate system of the image information to generate an image ahead of the vehicle that is matched with a single coordinate system; normalizing the information on the reflected amount; separating a region of road surface and a region of non-road surface each other using the distance information to determine a region of interest (ROI); and recognizing one or more markers on the basis of the image, the normalized information on the reflected amount, and the ROI.

In the embodiments, the performing a transformation process includes: transforming the coordinate system on the basis of camera parameters obtained from a calibration process of the camera to generate a bird-view image; and removing noise from the bird-view image to generate the image.

In the embodiments, the normalizing the information on the reflected amount includes: generating a histogram for the information on the reflected amount; and performing a normalization process for the information on the reflected amount on the basis of the histogram.

In the embodiments, the separating a region of road surface and a region of non-road surface each other includes: generating a three-dimensional elevation map ahead of the vehicle using the distance information; and separating a region of road surface and a region of non-road surface each other on the basis of the three-dimensional elevation map, thereby determining the ROI for recognition of the road markers.

In the embodiments, the recognizing one or more markers includes: extracting edges of the ROI from the image; performing a line fitting based on the extracted edges; selecting groups of road marker candidates in consideration of direction and size of the road markers; and recognizing one or more road marker candidate from the selected group of road marker candidates based on the information on the reflected amount.

### BRIEF DESCRIPTION OF THE DRAWINGS

The above and other objects and features of the present invention will become apparent from the following description of embodiments given in conjunction with the accompanying drawings, in which:

FIG. 1 illustrates a view explaining a concept of an apparatus for recognizing road markers in accordance with the present invention;

FIG. 2 illustrates a block diagram of an apparatus for recognizing road markers in accordance with the present invention; and

FIG. 3 is a flow chart illustrating a process of recognizing road markers in accordance with the embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

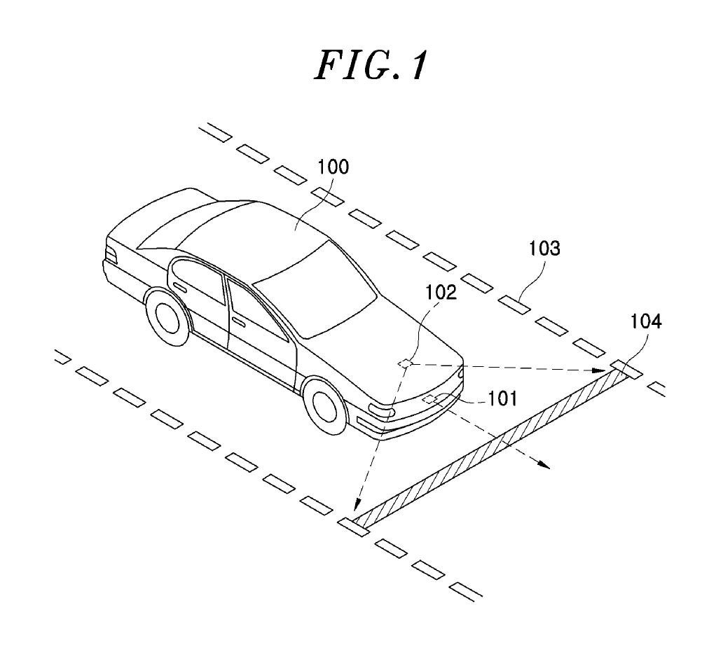

FIG. 1 illustrates a view explaining a concept of an apparatus for recognizing road markers in accordance with the present invention.

Referring to FIG. 1, an apparatus for recognizing road markers senses a road marker such as a traffic lane 103 and a stop line 104 on a road. The apparatus includes a single color camera 101 to watch the road ahead of a vehicle 100 and a laser scanner 102 to sense the distance from the road marker on the road and the reflected amount from the road.

An operation principle of the apparatus for recognizing road markers having such construction as FIG. 1 will be described below.

First, the apparatus for recognizing the road markers generates a three-dimensional elevation map using distance information provided from the laser scanner 102 and performs a process to separate a region of road surface and a region of non-road surface having a given height each other, thereby providing region information, and discriminates the road markers from a road surface based on the reflected amount from each position on a road surface. The single color camera 101 provides image information on color and form of the road markers ahead of the vehicle 100. For example, assuming that a vehicle 100 provided with the apparatus for recognizing road markers of the embodiment drives in a road environment where there is a center lane on the left of the vehicle 100, a travel lane on the right of the vehicle 100 and a yellow stop line 104 ahead of the vehicle, the apparatus determines a region ahead of the vehicle 100 where the vehicle can drive on the basis of information provided from the laser scanner 102, recognizes a size and form of both lanes 103 with reference to the image information provided from the single color camera 101 and the reflected amount from the laser scanner, and recognizes color of the lanes 103 based on the image information provided from the single color camera 101.

Subsequently, the apparatus determines a relative position between both lanes 103 and the vehicle 100. Further the apparatus determines whether there is a stop line 104 ahead of the vehicle 100 and where is the stop line 104 and a size and form of the stop line 104 obtained by the reflected amount of the laser scanner 102 and color obtained by the image information.

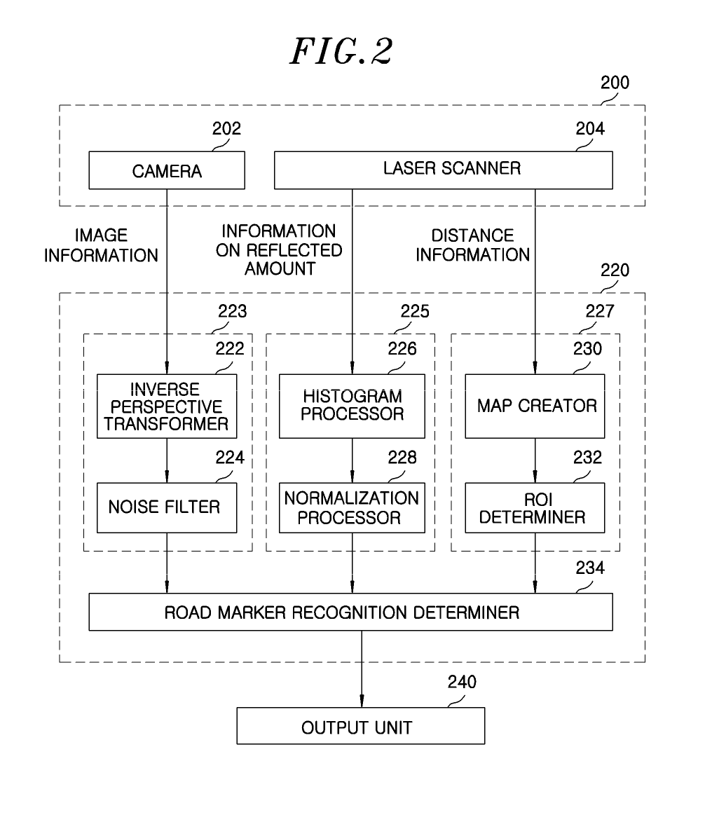

A detailed construction of the apparatus for recognizing road markers in accordance with an embodiment of the present invention will be described with reference to FIG. 2.

FIG. 2 illustrates a block diagram of an apparatus for recognizing road markers in accordance with the present invention in detail. The apparatus includes a sensor unit 200, a recognizer unit 220 and an output unit 240.

The sensor unit 200 watches a road ahead of a vehicle 100 provided equipped the apparatus and recognizes road markers, e.g, lanes 103 and a stop line 104, on a road surface ahead of the vehicle 100. The sensor unit 200 includes a camera 202 and a laser scanner 204.

The camera 202 provides the recognizer unit 220 with the image information ahead of the vehicle 100 and the laser scanner 204 provides the recognizer unit 220 with the distance information and the information on the reflected amount of the laser scanner 204.

The camera 202 may be forward inclined and mounted towards to watch the road surface ahead of the vehicle 100. The camera 202 captures a color image of the road markers on the road surface ahead of the vehicle 100 in order to extract color and image of the road markers. The color image is then provided to the recognizer unit 220.

The laser scanner 204 is also forward inclined and mounted to radiate laser beam and scans the road surface ahead of the vehicle 100. The laser scanner 204 obtains distance information representing the relative position between the vehicle 100 and the road markers and the height of the road markers. Further, the laser scanner 204 obtains information on the reflected amount representative of the color and brightness level each of the road markers positioned on the road. The information obtained by the laser scanner 204 is then provided to the recognizer unit 220.

The recognizer unit 220 transforms the coordinate system of the image information provided from the camera 202 and generates an image with the transformed coordinate system. The recognizer unit 220 includes an image information processor 223, a reflected amount information processor 225, a distance information processor 227, and a road marker recognition determiner 234. The image information processor 223 includes an inverse perspective transformer 222 that transforms the image of the projected coordinate system into a bird-view image on the basis of internal/external camera parameters obtained through a calibration process of the camera 202 and a noise filter 224 to remove noise from the transformed bird-view image for obtaining an improved transformed bird-view image.

The reflected amount information processor 225 normalizes the information on the reflected amount of the road surface provided from the laser scanner 204. To this end, the reflected amount information processor 225 includes a histogram processor 226 to generate histogram with respect to the reflected amount of the road surface and a normalization processor 228 to normalize the reflected amount level on the basis of the histogram.

The distance information processor 227 establishes a region of interest (ROI) based on the distance information provided from the laser scanner 204. To this end, the distance information processor 227 includes a map creator 230 to generate a three-dimensional elevation map with respect to the road ahead of the vehicle 100 using the distance information provided from the laser scanner 204 and an ROI determiner 232 to separate the region of road surface and the region of non-road surface each other based on the elevation map and determine ROI used to recognize the road markers.

The information on the reflected amount which is subjected to the normalization, the bird-view image from which noise is removed, and the ROI is then provided to the road marker recognition determiner 234.

The road marker recognition determiner 234 determines the road markers based on the information on the bird-view image, the reflected amount and the ROI. More specifically, the road marker recognition determiner 234 performs a noise removal process on the ROI determined in the ROI determiner 232 and an edge extraction and a line fitting process on the ROI image with removed noise, separates the road markers and the road surface on the basis of the reflected amount level in the image, and finally determines the form and position of the road surface and the road markers using a probabilistic approach. The information on the form and position of the road surface and the road markers is then provided to the output unit 240.

The output unit 240 presents information in order that a driver of the vehicle 100 can easily recognize whether there is the road markers and relative position of the road markers determined in the road marker recognition determiner 234. For traffic lanes, the output 240 provides information on distance between traffic lanes 103 and the vehicle 100, and color, form, gradient, presence/absence of traffic lanes 103 ahead of the vehicle 100, or the like. For road markers such as a stop line/speed bump/crosswalk, the output 240 provides information on whether there is any mark ahead of the vehicle 100 and a relative position between the road marls and the vehicle 100.

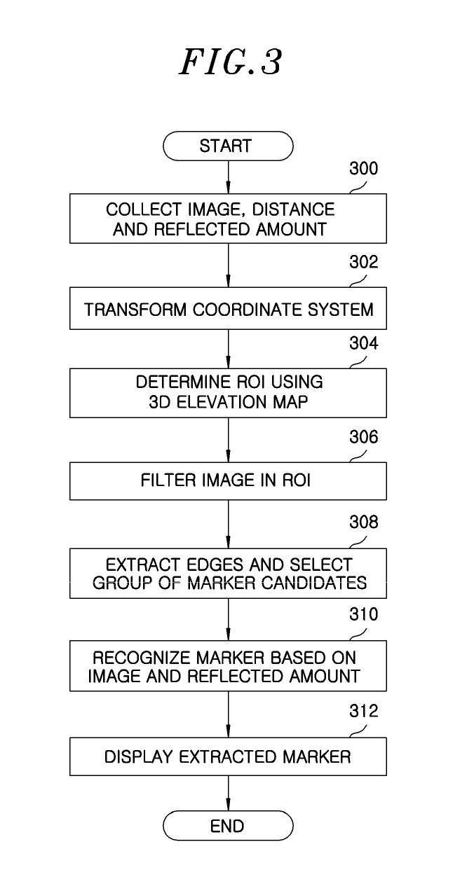

FIG. 3 is a flow chart illustrating a process of recognizing the road markers in accordance with the embodiment of the present invention.

Referring to FIG. 3, in operation 300, the recognizer unit 220 collects sensor data detected on the road ahead of the vehicle 100, that is, information on the image, distance and reflected amount of the road surface via the sensor unit 200.

Subsequently, in operation 302, the recognizer unit 220 performs a process to transform respective different coordinate systems in order to match them with a single coordinate system in consideration of an image coordinate system projected on the camera 202 and the installation position of the laser scanner 204. That is, the image of the road surface provided from the camera 202 is transformed into a bird-view image using a projected coordinate system based on the internal/external camera parameters obtained by a calibration process of the camera 202.

Further, in operation 304, the recognizer unit 220 generates a three-dimensional elevation map indicating a region of road surface ahead of the vehicle and region of non-road surface having a given height, and determines a ROI where the road markers are regarded to be existed on the basis of the three-dimensional elevation map.

Thereafter, in operation 306, the recognizer unit 220 performs a filtering to remove the noise from and improve the bird-view image. In operation 308, the recognizer unit 220 then extracts edges from the region of interest, and selects a group of road mark candidates in consideration of direction and size of the road markers using a fine fitting method such as Hoffman transformation method on the basis of the extracted edge.

Subsequently, the recognizer unit 220 finally recognizes one or more road markers from the group of road mark candidates using a probabilistic approach on the basis of the reflected amount level in operation 5310, and displays the recognized road markers via the output unit 240 for recognition of the road marks in operation 5312.

In accordance with an embodiment of the present invention, it is possible to provide a high recognition rate and a reliability for the road markers without being affected by changes of illumination and weather, and environmental change such as shadow, by recognizing the road markers such as a traffic lane, stop line, crosswalk and speed bump using a camera image, distance information and information on the reflected amount, and extracting information on whether there are road markers and their positions using the recognized result.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for recognizing road markers for use in a vehicle, the apparatus comprising:
a sensor unit configured to collect image information ahead of the vehicle, distance information, and information on the reflected amount of a road surface;
a recognizer unit configured to recognize the road markers ahead of the vehicle on the basis of the image information, distance information, and information on the reflected amount provided from the sensor unit; and
an output unit configured to provide information on the road markers recognized in the recognizer unit.

2. The apparatus of claim 1, wherein the sensor unit comprises:
a camera configured to take an image ahead of the vehicle to generate the image information; and
a laser scanner configured to generate the distance information and the information on the reflected amount.

3. The apparatus of claim 2, wherein the recognizer unit comprises:
an image information processor configured to perform a transformation process of the image provided from the camera to generate an image ahead of the vehicle that is matched with a single coordinate system;
a reflected amount information processor configured to normalize the information on the reflected amount;
a distance information processor configured to separate a region of road surface and a region of non-road surface each other using the distance information to determine a region of interest (ROI); and
a road marker recognition determiner configured to determine one or more road marker on the basis of the image, the normalized information on the reflected amount, and the region of interest.

4. The apparatus of claim 3, wherein the image information processor comprises:
an inverse perspective transformer configured to transform the coordinate system of the image provided from the camera on the basis of camera parameters obtained from a calibration process of the camera to generate a bird-view image; and
a noise filter configured to remove noise from the bird-view image to generate the image.

5. The apparatus of claim 3, wherein the reflected amount information processor comprises:
a histogram processor configured to generate a histogram for the information on the reflected amount provided from the laser scanner; and
a normalization processor configured to perform a normalization process for the information on the reflected amount on the basis of the histogram.

6. The apparatus of claim 3, wherein the distance information processor comprises:
a map creator configured to create a three-dimensional elevation map for the road ahead of the vehicle using the distance information; and
a ROI determiner configured to separate a region of road surface and a region of non-road surface each other on the basis of the three-dimensional elevation map to determine the ROI for recognition of the road markers.

7. The apparatus of claim 3, wherein the road marker recognition determiner extracts edges in the ROI from the image, perform a line fitting based on the extracted edges, selects a group of road marker candidates in consideration of direction and size of the road markers, and recognize one or more road marker candidates from the group of road marker candidates based on the information on the reflected amount, thereby determining the one or more road markers.

8. A method for recognizing road markers for used in a vehicle, the method comprising:
sensing image information ahead of the vehicle, distance information, and information on the reflected amount of a road surface;
recognizing road markers ahead of the vehicle on the basis of the image information, distance information, and information on the reflected amount; and
presenting information on the recognized markers.

9. The method of claim 8, wherein said sensing image information ahead of the vehicle comprises:
taking an image ahead of the vehicle using a camera to generate the image information; and
scanning the road surface ahead of the vehicle to generate the distance information and information on the reflected amount.

10. The method of claim 9, wherein said recognizing road markers ahead of the vehicle comprises:
performing a transformation process on a coordinate system of the image information to generate an image ahead of the vehicle that is matched with a single coordinate system;
normalizing the information on the reflected amount;
separating a region of road surface and a region of non-road surface each other using the distance information to determine a region of interest (ROI); and
recognizing one or more markers on the basis of the image, the normalized information on the reflected amount, and the ROI.

11. The method of claim 10, wherein said performing a transformation process comprises:
transforming the coordinate system on the basis of camera parameters obtained from a calibration process of the camera to generate a bird-view image; and
removing noise from the bird-view image to generate the image.

12. The method of claim 10, wherein said normalizing the information on the reflected amount comprises:
generating a histogram for the information on the reflected amount; and
performing a normalization process for the information on the reflected amount on the basis of the histogram.

13. The method of claim 10, wherein said separating a region of road surface and a region of non-road surface each other comprises:
generating a three-dimensional elevation map ahead of the vehicle using the distance information; and
separating a region of road surface and a region of non-road surface each other on the basis of the three-dimensional elevation map, thereby determining the ROI for recognition of the road markers.

14. The method of claim 10, wherein said recognizing one or more markers comprises:
extracting edges of the ROI from the image;
performing a line fitting based on the extracted edges;
selecting groups of road marker candidates in consideration of direction and size of the road markers; and
recognizing one or more road marker candidate from the selected group of road marker candidates based on the information on the reflected amount.
